(19) United States
(12) Patent Application Publication
(10) Pub. No.: US 2017/0330090 A1
(43) Pub. Date: Nov. 16, 2017

(54) METHOD AND A SYSTEM FOR OPTIMZING STABILITY OF A PROJECT

(71) Applicant: WIPRO LIMITED, BANGALORE (IN)

(72) Inventors: VENKATA SUBRAMANIAN JAYARAMAN, CHENNAI (IN); SUMITHRA SUNDARESAN, CHENNAI (IN); RAJIV KUMAR AGRAWAL, BANGALORE (IN)

(21) Appl. No.: 15/473,652

(22) Filed: Mar. 30, 2017

Related U.S. Application Data
(63) Continuation-in-part of application No. 15/196,258, filed on Jun. 29, 2016.

(30) Foreign Application Priority Data
May 11, 2016 (IN) 201641016472

(51) Int. Cl. G06N 5/04

(52) U.S. Cl. CPC G06N 5/04

(57) ABSTRACT

The present disclosure relates to a method and a system for optimizing stability of a project. A predictive analysis system receives data related to defect parameters, developer parameters, test case parameters, requirement parameters and production defect parameters of a project from data sources. Thereafter, the predictive analysis system determines plurality of trends based on the received data. Further, the predictive analysis system determines a project release prediction value for the project based on the plurality of trends. Further, the predictive analysis system determines an impact value of the project based on the plurality of trends. Further, the predictive analysis system determines a prediction result value based on the project release prediction value and the impact value for predicting the stability of the project. Further, the predictive analysis system dynamically performs one or more actions based on the prediction result value for optimizing the stability of the project.

### TECHNICAL FIELD

The present subject matter is related, in general to data analytics, and more particularly, but not exclusively to a method and a system for optimizing stability of a project.

### BACKGROUND

Data Analytics has taken over the world for providing details regarding each and every activity that happens in any field. One of the major uses of data analytics is the predictions that can be made based on the analysis and co-relate the results obtained to the overall success that could be achieved. Quality engineering is a field where analytics is performed based on the abundant data available but very minimum predictions are made.

Currently providing insights on quality assurance to improve predictive analytics of a project is of the utmost importance. Predictive analytics means to tell what the future is by looking at the past and analysing the data that is present. Few methods for performing predictive analysis include using decision trees, using a hypothesis, using decision analytics and using some generic algorithm. However, these methods provide results on predictions on very small areas like defect trend, execution trend and the outcome of release of the project.

Existing techniques provide several methods for determining quality of project. Some of the existing techniques identify faults based on only the source code of a project whereas as other few take into consideration the architecture of the project, construction and test cases related to the project. The issues with the existing techniques are that, only a single parameter or only limited number of parameters are considered for the analysis and prediction of details related to the project. By considering only limited number of parameters, the analysis of the project is restricted for those parameters. Therefore, the existing techniques are not capable of providing a holistic view of the project. Further, the existing techniques concentrate more towards analysis of the project after the project is built and less towards predictions related to the project during its building.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Disclosed herein are a method and a system for optimizing stability of a project. For optimizing stability of the project, firstly, predictive analysis system determines plurality of trends related to the project. The plurality of trends may consider all the parameters involved in the project such as defect parameters indicating defect information of the project, developer parameters indicating developer information of the project, test case parameters indicating test cases used for the project, requirement parameters indicating requirements for the project and production defect parameters indicating defects in production of the project. Based on the plurality of trends, the predictive analysis system determines stability of the project. Determining the stability based on the plurality of trends provides an overall view of the project for providing a prediction inference. Further, the stepwise method for determining the plurality of trends easily identifies the issues in development of the project at any stage.

Accordingly, the present disclosure relates to a method for optimizing stability of a project. The method comprises receiving, by a predictive analysis system, data related to defect parameters, developer parameters, test case parameters, requirement parameters and production defect parameters of a project from one or more data sources. Thereafter, the predictive analysis system determines plurality of trends based on at least one of the data related to the defect parameters, the test case parameters, the developer parameters, the production defect parameters and the requirement parameters. Further, the predictive analysis system determines a project release prediction value for the project based on at least one of the plurality of trends. The project release prediction value indicates completeness of the project and level of correctness of at least one of the plurality of trends for release of the project. Upon determining the project release prediction value, the predictive analysis system determines an impact value of the project based on at least one of the plurality of trends. The impact value indicates impact of at least one of the plurality of trends on production release of the project. Further, the predictive analysis system determines a prediction result value based on the project release prediction value and the impact value for predicting the stability of the project. Finally, the predictive analysis system dynamically performs one or more actions based on the prediction result value for optimizing the stability of the project.

Further, the present disclosure relates to a predictive analysis system for optimizing stability of a project. The predictive analysis system comprises a processor and a memory communicatively coupled to the processor. The memory stores the processor-executable instructions, which, on execution, causes the processor to receive data related to defect parameters, developer parameters, test case parameters, requirement parameters and production defect parameters of a project from one or more data sources. Upon receiving the data, the processor determines plurality of trends based on at least one of the data related to the defect parameters, the test case parameters, the developer parameters, the production defect parameters, and the requirement parameters. Further, the processor determines a project release prediction value for the project based on at least one of the plurality of trends. The project release prediction value indicates completeness of the project and level of correctness of at least one of the plurality of trends for release of the project. Upon determining the project release prediction value, the processor determines an impact value of the project based on at least one of the plurality of trends. The impact value indicates impact of at least one of the plurality of trends on production release of the project. Further, the processor determines a prediction result value based on the project release prediction value and the impact value for predicting the stability of the project. Finally, the processor dynamically performs one or more actions based on the prediction result value for optimizing the stability of the project.

Further, the present disclosure relates to a non-transitory computer-readable storage medium having stored thereon, a set of computer-executable instructions for causing a computer comprising one or more processors to perform steps comprising receiving data related to defect parameters, developer parameters, test case parameters, requirement parameters, and production defect parameters of a project from one or more data sources and determining plurality of trends based on at least one of the data related to the defect parameters, the test case parameters, the developer parameters, the production defect parameters, and the requirement parameters. The steps further comprise determining a project release prediction value for the project based on at least one of the plurality of trends, wherein the project release prediction value indicates completeness of the project and level of correctness of at least one of the plurality of trends for release of the project and determining an impact value of the project based on at least one of the plurality of trends, wherein the impact value indicates impact of at least one of the plurality of trends on production release of the project. The steps further comprise determining a prediction result value based on the project release prediction value and the impact value for predicting the stability of the project and performing dynamically one or more actions based on the prediction result value for optimizing the stability of the project.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DIAGRAMS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

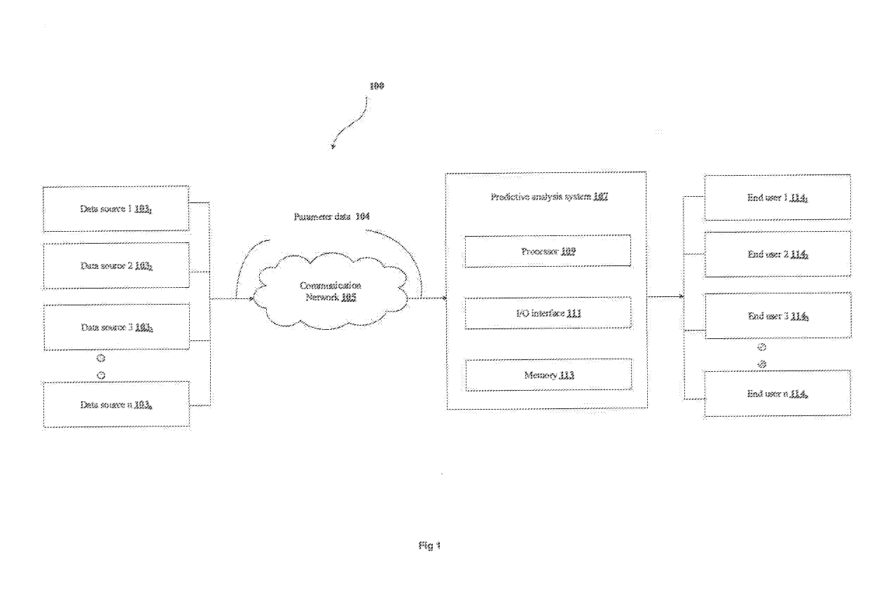

FIG. 1 shows an exemplary architecture for optimizing stability of a project, in accordance with some embodiments of the present disclosure;

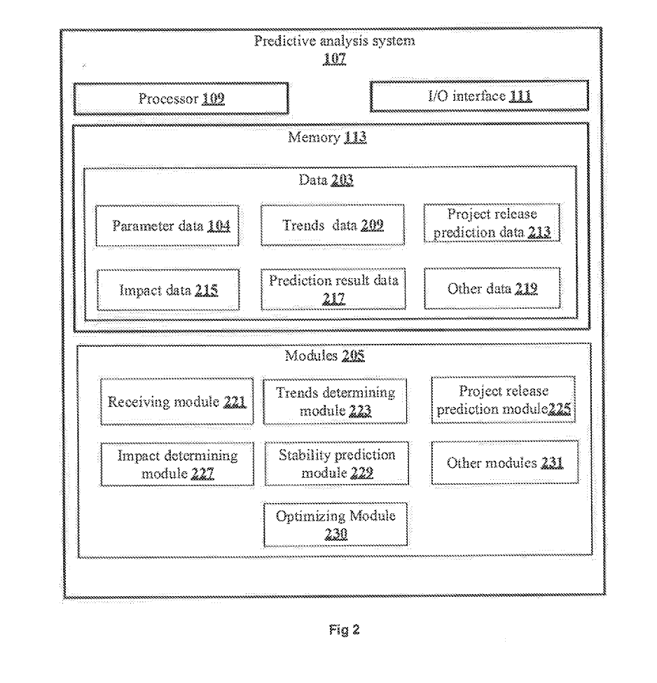

FIG. 2 shows a detailed block diagram of a predictive analysis system for optimizing stability of a project, in accordance with some embodiments of the present disclosure;

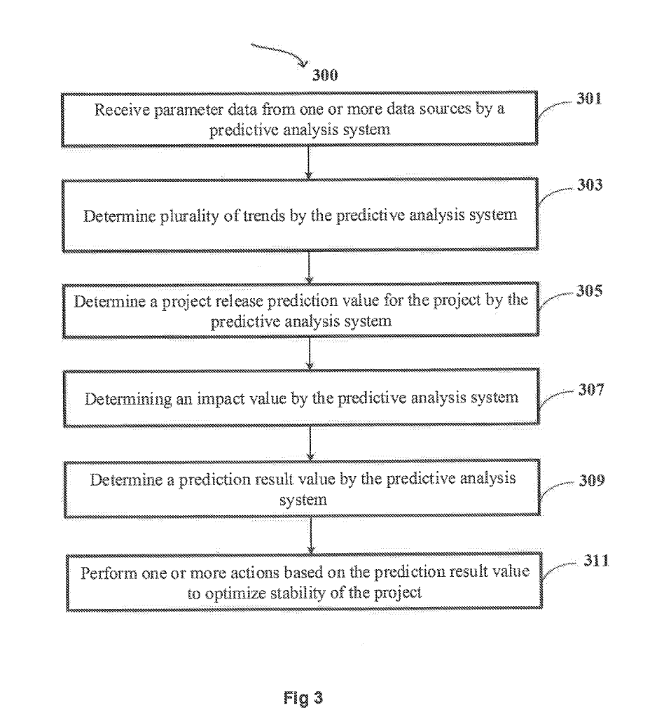

FIG. 3 illustrates a flowchart for optimizing stability of a project, in accordance with some embodiments of the present disclosure; and

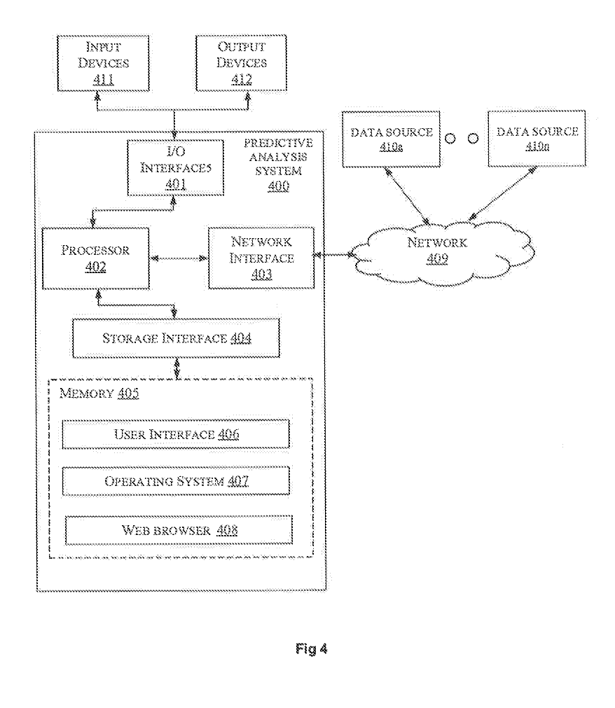

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a system for optimizing stability of a project. A predictive analysis system receives data related to the project from one or more data sources. As an example, the data may include, but is not limited to, data related to defect parameters, developer parameters, test case parameters, requirement parameters, and production defect parameters. The received data is used to determine plurality of trends for the project. The plurality of trends may comprise a first trend, a second trend, a third trend and a fourth trend.

The first trend provides insights on the stability of the project based on the defect parameters and the test case parameters. The second trend provides insights on the developer of the project based on the developer parameters. The third trend provides insights on the production defects raised in a system and whether the production defects were fixed or not, based on the production defect parameters. The fourth trend provides insights on performance of testing team of the project based on the test case parameters, the defect parameters and the requirement parameters. The plurality of trends is determined based on one or more predefined techniques. Further, a release project prediction value and an impact value are determined based on the determined plurality of trends. Based on the release project prediction value and the impact value, a prediction result value is determined that predicts stability of the project. The determined prediction result value provides a way of deciding if the project is ready for release. Further, the stability can be determined at any stage during project building that gives an insight on the project at every stage and helps in preventing wastage of any valuable resources in case there is a discrepancy. By considering all the parameters required to assess a project, the method gives a structured result that provides a holistic view of the project and also understanding of the project at a granular level. Further, the method optimizes the stability of the project by dynamically performing one or more actions based on the prediction result value. The one or more actions may include modifying at least one of the defect parameters, the test case parameters, the developer parameters, the production defect parameters, and the requirement parameters to modify the prediction result value.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

FIG. 1 shows an exemplary architecture for optimizing stability of a project, in accordance with some embodiments of the present disclosure.

The architecture 100 comprises one or more data sources, data source 1 1031 to data source n 103n (collectively referred to as one or more data sources 103), a communication network 105, a predictive analysis system 107 and one or more end users, end user 1 1141 to end user n 114n (collectively referred to as one or more end users 114). As an example, the one or more data sources 103 may include, but not limited to, a management system like test management system, one or more databases like skill database of developers of a project, knowledge repositories etc. and user inputs. The one or more data sources 103 are configured to collect parameter data 104 related to the project. As an example, the parameter data 104 may be data related to defect parameters, developer parameters, test case parameters, requirement parameters, and production defect parameters of the project. The parameter data 104 is provided to the predictive analysis system 107 through the communication network 105. As an example, the communication network 105 may be at least one of wired communication network and wireless communication network.

The predictive analysis system 107 is not limited for determining only stability of the project. It may be used for any kind of applications which involves data analytics. The predictive analysis system 107 predicts and optimizes the stability of the project and provides information related to the stability of the project and information related to trending of the project to the one or more end users 114. As an example, the one or more end users 114 may be a stakeholder of an organization, a project head etc. In an embodiment, the predictive analysis system 107 provides the information to the one or more end users through one or more means which includes, but not limited to, Email portal and SharePoint portal.

The predictive analysis system 107 comprises a processor 109, an I/O interface 111 and a memory 113. The I/O interface 111 is configured to receive the parameter data 104 i.e. the data related to the defect parameters, the developer parameters, the test case parameters, the requirement parameters and the production defect parameters of the project from the one or more data sources 103. The data related to the defect parameters comprises information about defects in the project. As an example, the defect parameters may include, but not limited to, total number of defects in the project, type of the defects, criticality of the defects, severity of the defects and root cause of the defects. The data related to the developer parameters comprises information about developer of the project. As an example, the developer parameters may include, but not limited to, knowledge level of the developer, experience of the developer in project development, defects introduced by the developer previously, and number of trainings underwent by the developer. The data related to the test case parameters comprises information about the test cases of the project. As an example, the test case parameters may include, but not limited to, total number of test cases created, total number of test cases executed, priority of the test cases, and status of the test cases. In an embodiment, the priority of the test cases and the status of the test cases together are referred to as criticality of the test cases. The data related to the requirement parameters comprises information about the requirements of the project. As an example, the requirement parameters may include, but not limited to, total number of requirements available for the project, total number of defects in the requirements and industry standard of the requirements. In an embodiment, the requirement parameters may include, but not limited to, functional requirements, technical requirements, non-functional requirements and resource requirements. As an example, the functional requirements may be based on a user interface that states what kind of value needs to be displayed. As an example, the technical requirements may be Extract Transform and Load (ETL) based requirements for stating which query and source data needs to be used. As an example, the non-functional requirements may be performance based requirements that state at what speed a webpage has to provide a response. As an example, the resource requirements may be related to resources such as facilities, equipment, funds etc. that are required for development of the project. The data related to the production defect parameters comprises information about defects related to production of the project. As an example, the production defect parameters may include, but not limited to, overall experience of the developer of project, criticality of the production defects, recurrence of the production defects and total number of production defects introduced by the developer.

The received parameter data 104 is stored in the memory 113. The processor 109 determines a plurality of trends based on the received parameter data 104. In an embodiment, the plurality of trends comprises a first trend, a second trend, a third trend and a fourth trend. The first trend provides insights on the stability of the project based on the defect parameters and the test case parameters. The second trend provides insights on the developer of the project based on the developer parameters. The third trend provides insights on the production defects raised in a system and whether the production defects were fixed or not, based on the production defect parameters. The fourth trend provides insights on performance of testing team of the project based on the test case parameters, the defect parameters and the requirement parameters.

The first trend is calculated based on the defect parameters and the test case parameters using a first predefined technique as shown in the below mentioned equation (Equation 1).

First trend=(Type of the defect+criticality of the defect+severity of the defect+criticality of the test case)*(total number test cases created−total number of test cases executed)/(total number of defects) Equation 1

The second trend is calculated based on the developer parameters using a second predefined technique as shown in the below mentioned equation (Equation 2).

Second trend=(Knowledge level of the developer*experience of the developer in project development*number of trainings underwent by the developer/total defects introduced by the developer previously) Equation 2

In an embodiment, when there is more than one developer involved in development of the project, average of values associated with each developer parameter corresponding to each developer is used for determining the second trend. As an example, consider a scenario where the project is developed by 5 developers. Further, consider the developer parameter “knowledge level of the developer”. In this scenario, value associated with the developer parameter “knowledge level of the developer” is equal to average of values associated with the developer parameter “knowledge level of the developer” for each developer. Similarly, the average of values associated with each developer parameter corresponding to each developer is determined. Further, the average associated with each developer parameter is substituted in the Equation 2 to determine the second trend corresponding to all the 5 developers involved in the development of the project.

The third trend is calculated based on the production defect parameters using a third predefined technique as shown in the below mentioned equation (Equation 3).

Third trend=Overall experience of the developer of project/(total number of production defects+(criticality of the production defect*recurrence of the production defect)) Equation 3.

In an embodiment, value associated with the overall experience of the developer of the project is the value of the second trend, which is determined using the Equation 2. In another embodiment, when there is more than one developer involved in the development of the project, the second trend determined corresponding to all the developers involved in the development of the project is used for determining the third trend. Further, average is determined for the values associated with each production defect parameter corresponding to each developer and substituted in the Equation 3. As an example, consider a scenario where the project is developed by 5 developers. Therefore, value associated with the production defect parameter “total number of production defects” is determined by computing average of the values associated with the production defect parameter “total number of production defects” for each developer. Similarly, the average of values associated with each production defect parameter corresponding to each developer is determined. Further, the average associated with each production defect parameter is substituted in the Equation 3 to determine the third trend corresponding to all the 5 developers involved in the development of the project.

The fourth trend is calculated based on the test case parameters, the defect parameters and the requirement parameters using a fourth predefined technique as shown in the below equation (Equation 4)

Fourth Trend=(Total number of test cases executed/(total number of defects−requirement stability))*2 Equation 4

In an embodiment, the requirement stability is calculated based on the requirement parameters using a fifth predefined technique as shown in the below equation (Equation 5).

Requirements Stability=Total number of defects in the requirements/total number of requirements available for the project Equation 5

The processor 109 uses the first trend and the third trend to determine a project release prediction value for the project using a sixth predefined technique as shown in the below mentioned equation (Equation 6).

Project release prediction value=First trend/third trend Equation 6

In an embodiment, the project release prediction value quantifies the completeness of the project to check if the project is ready for release. Further, the project release prediction value checks the level of correctness of the plurality of trends i.e. the project release prediction value indicates possibility of wrong trending and possibility of correct trending of the project based on the plurality of trends.

The processor 109 uses the second trend and the fourth trend to determine an impact value using a seventh predefined technique as shown in the below mentioned equation (Equation 7).

Impact value=Second trend*fourth trend Equation 7

In an embodiment, the impact value provides important information about production release of the project based on skill of the developer of the project and testing team. The impact value indicates impact of the second trend and the fourth trend on the production release of the project.

Upon determining the project release prediction value and the impact value, a prediction result value is determined based on the project release prediction value and the impact value using a eighth predefined technique as shown in the below mentioned equation (Equation 8).

Prediction result value=(Impact value/project release prediction value)*100 Equation 8

The prediction result value is a percentage value based on which an inference is made to predict the stability of the project. Upon identifying the prediction result value, the stability of the project based on the prediction result value is notified to the one or more end users 114 through the I/O interface 111. In one embodiment, upon identifying the prediction result value, one or more actions may be dynamically performed to optimize the stability of the project. In an example, if the prediction result value is below a threshold value, the one or more actions may be dynamically performed to modify the prediction result value. The prediction result value may be modified to a value above the threshold value. The prediction result value may be modified by modifying at least one of the defect parameters, the test case parameters, the developer parameters, the production defect parameters, and the requirement parameters.

FIG. 2 shows a detailed block diagram of a predictive analysis system for optimizing stability of a project, in accordance with some embodiments of the present disclosure.

In one implementation, the I/O interface 111 in the predictive analysis system 107, receives parameter data 104 from one or more data sources 103. As an example, the parameter data 104 is stored in a memory 113 configured in the predictive analysis system 107. In one embodiment, data 203 includes the parameter data 104, trends data 209, project release prediction data 213, impact data 215, prediction result data 217 and other data 219. In the illustrated FIG. 2, modules 205 stored in the memory 113 are described herein in detail.

In one embodiment, the data 203 may be stored in the memory 113 in the form of various data structures. Additionally, the aforementioned data can be organized using data models, such as relational or hierarchical data models. The other data 219 may store data, including temporary data and temporary files, generated by modules 205 for performing the various functions of the predictive analysis system 107.

In one embodiment, the parameter data 104 is received from the one or more data sources 103. The parameter data 104 comprises data related to defect parameters, developer parameters, test case parameters, requirement parameters and production defect parameters of the project from the one or more data sources 103. The data related to the defect parameters comprises information about defects in the project. As an example, the defect parameters may include, but not limited to, total number of defects in the project, type of the defects, criticality of the defects, severity of the defects and root cause of the defects. The data related to the developer parameters comprises information about developer of the project. As an example, the developer parameters may include, but not limited to, knowledge level of the developer, experience of the developer in project development, defects introduced by the developer previously and number of trainings underwent by the developer. The data related to the test case parameters comprises information about the test cases of the project. As an example, the test case parameters may include, but not limited to, total number of test cases created, total number of test cases executed, priority of the test cases and status of the test cases. The data related to the requirement parameters comprises information about the requirements of the project. As an example, the requirement parameters may include, but not limited to, total number of requirements available for the project, total number of defects in the requirements and industry standard of the requirements. The data related to the production defect parameters comprises information about defects related to production of the project. As an example, the production defect parameters may include, but not limited to, overall experience of the developer, criticality of the production defects, recurrence of the production defects and total number of production defects introduced by the developer.

In an embodiment, the trends data 209 comprises data related to a plurality of trends of the project. The plurality of trends may be a first trend, a second trend, a third trend and a fourth trend. The first trend provides insights on the stability of the project. The first trend may be determined using a first predefined technique as shown in Equation 1. The second trend provides insights on the developer of the project. The second trend may be determined using a second predefined technique as shown in Equation 2. The third trend provides insights on the production defects raised on a system and whether the production defects were fixed or not. The third trend is determined using a third predefined technique as shown in Equation 3. The fourth trend provides insights on performance of testing team of the project. The fourth trend is determined using a fourth predefined technique and a fifth predefined technique as shown in Equations 4 and 5 respectively.

In an embodiment, the project release prediction data 213 comprises the project release prediction value that quantifies the completeness of the project to check if the project is ready for release. Further, the project release prediction value checks the level of correctness of the plurality of trends. The project release prediction value is determined using the first trend and the third trend. A sixth predefined technique as shown in Equation 6 is used to determine the project release prediction value.

In one embodiment, the impact data 215 comprises the impact value that provides important information about production release of the project based on skill of the developer of the project and testing team. The impact value is determined using the second trend and the fourth trend. A seventh predefined technique as shown in Equation 7 is used to determine the impact value.

In one embodiment, the prediction result data 217 comprises the prediction result value of the project. The prediction result value is a percentage value that predicts the stability of the project. The prediction result value is determined based on the project release prediction value and the impact value. An eighth predefined technique as shown in Equation 8 is used to determine the prediction result value.

In an embodiment, the data stored in the memory 113 is processed by the modules 205 of the predictive analysis system 107. The modules 205 may be stored within the memory 113. In an example, the modules 205, communicatively coupled to a processor 109 configured in the predictive analysis system 107, may also be present outside the memory 113 as shown in FIG. 2 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the modules 205 may include, for example, a receiving module 221, trends determining module 223, a project release prediction module 225, an impact determining module 227, a stability prediction module 229, an optimizing module 230, and other modules 231. The other modules 231 may be used to perform various miscellaneous functionalities of the predictive analysis system 107. It will be appreciated that such aforementioned modules 205 may be represented as a single module or a combination of different modules.

In an embodiment, the receiving module 221 receives the parameter data 104 from the one or more data sources 103 configured to collect the parameter data 104. As an example, the one or more data sources 103 may include, but not limited to, a management system like test case management system, one or more databases like skill database of developers of a project, knowledge repositories etc. and user inputs.

In an embodiment, the trends determining module 223 determines the first trend, the second trend, the third trend and the fourth trend. The first trend is calculated based on the defect parameters and the test case parameters. As an example, the defect parameters may include, but not limited to, total number of defects in the project, type of the defects, criticality of the defects, severity of the defects and root cause of the defects. As an example, the test case parameters may include, but not limited to, total number of test cases created, total number of test cases executed, priority of the test cases and status of the test cases. The trends determining module 223 classifies one or more of the defect parameters and one or more of the test case parameters into one or more predefined categories. As an example, the one or more of the defect parameters to be classified may be type of the defects, criticality of the defects and severity of the defects. As an example, the one or more of the test case parameters to be classified may be priority of the test cases and status of the test cases.

The one or more predefined categories associated with the type of the detects are “design” and “construction”. The predefined category “design” indicates the defects found during the design of the project. The predefined category “construction” indicates the defects found during the construction of the project.

The predefined categories “design” and “construction” are assigned with a first predefined scaling value. The first predefined scaling value of the predefined categories for the type of the defects is as shown in the below Table 1.

TABLE 1

| | First Predefined |
|---|---|
| Predefined categories for type of the defects | scaling value |
| Design | 1 |
| Construction | 2 |

According to the above Table 1, the predefined category “design” is assigned with the first predefined scaling value 1 and the predefined category “construction” is assigned with the first predefined scaling value 2.

As an example, consider a scenario where the number of defects is 15.8 out of 15 defects belong to the “design” category and 7 out of 15 defects belong to the “construction” category. The value of the type of defects is calculated as shown in the below Table 2.

TABLE 2

| | | | Type of defect |
|---|---|---|---|
| Number of | Predefined categories | | value |
| defects | of the type of the | First Predefined | (n * predefined |
| (n) | defects | scaling value | scaling value) |
| 8 | Design | 1 | 8 * 1 = 8 |
| 7 | Construction | 2 | 7 * 2 = 14 |

Therefore, according to the above Table 2, the type of defect value associated with 8 defects of the “design” category is 8 and the type of defect value associated with 7 defects of the “construction” category is 14.

Similarly, the severity of the defects, the criticality of the defects, the priority of the test cases and the status of the test cases are categorized and their corresponding values are calculated.

The one or more predefined categories associated with the severity of the defects are “cosmetic”, “minor”, “major” and “critical”. The predefined categories “cosmetic”, “minor”, “major” and “critical” are assigned with a first predefined scaling value. The first predefined scaling value of the predefined categories for the severity of the defects as shown in the below Table 3.

TABLE 3

| | First Predefined |
|---|---|
| Predefined categories for severity of defects | scaling value |
| Cosmetic | 1 |
| Minor | 2 |
| Major | 3 |
| Critical | 4 |

According to the above Table 3, the predefined category “cosmetic” is assigned with the first predefined scaling value 1, the predefined category “minor” is assigned with the first predefined scaling value 2, the predefined category “major” is assigned with the first predefined scaling value 3 and the predefined category “critical” is assigned with the first predefined scaling value 4.

The one or more predefined categories associated with the criticality of the defects are “low”, “medium” and “high”. The predefined categories “low”, “medium” and “high” are assigned with a first predefined scaling value. The first predefined scaling value of the predefined categories for the criticality of the defects is as shown in the below Table 4.

TABLE 4

| | First Predefined |
|---|---|
| Predefined categories for criticality of defects | scaling value |
| Low | 1 |
| Medium | 2 |
| High | 3 |

According to the above Table 4, the predefined category “low” is assigned with the first predefined scaling value 1, the predefined category “medium” is assigned with the first predefined scaling value 2 and the predefined category “high” is assigned with the first predefined scaling value 3.

The one or more predefined categories associated with the priority of the test cases are “low”, “medium” and “high”. The predefined categories “low”, “medium” and “high” are assigned with a first predefined scaling value. The first predefined scaling value of the predefined categories for the priority of the test cases is as shown in the below Table 5.

TABLE 5

| | First Predefined |
|---|---|
| Predefined categories for priority of test cases | scaling value |
| Low | 1 |
| Medium | 2 |
| High | 3 |

According to the above Table 5, the predefined category “low” is assigned with the first predefined scaling value 1, the predefined category “medium” is assigned with the first predefined scaling value 2 and the predefined category “high” is assigned with the first predefined scaling value 3.

The one or more predefined categories associated with the status of the test cases are “passed” and “failed”. The predefined categories “passed” and “failed” are assigned with a first predefined scaling value. The first predefined scaling value of the predefined categories for the status of the test cases is as shown in the below Table 6.

TABLE 6

| | First predefined |
|---|---|
| Predefined categories for status of test cases | scaling value |
| Passed | 1 |
| Failed | −1 |

According to the above Table 6, the predefined category “passed” is assigned with the first predefined scaling value 1 and the predefined category “failed” is assigned with the first predefined scaling value−1.

Upon classification of the one or more of the defect parameters and the one or more of the test case parameters and assigning the first predefined scaling value to each of the one or more predefined categories, the trends determining module 223 determines the first trend. Table 7 comprises the first predefined scaling value for the one or more of the defect parameters, the first predefined scaling value for the one or more of the test case parameters, value associated with rest of the defect parameters and value associated with rest of the test case parameters. As an example, the trends determining module 223 determines the first trend using the Equation 1 by substituting the values from the below Table 7.

TABLE 7

| | Total | | | | Total | Total | | |
|---|---|---|---|---|---|---|---|---|
| | Number | Type | Criticality | Severity | test | test | Criticality | |
| | of | of the | of the | of the | cases | cases | of the | First |
| Project | defects | defect | defect | defect | created | executed | test case | Trend |
| A | 10 | 16 | 24 | 34 | 100 | 80 | 250 | 648 |
| B | 15 | 27 | 40 | 55 | 50 | 20 | 90 | 424 |
| C | 5 | 10 | 8 | 8 | 20 | 10 | 30 | 112 |

According to the above Table 7, the first trend computed for the project A is 648, the first trend computed for the project B is 424 and the first trend computed for the project C is 112. In an embodiment, higher the first trend better will be the trend of the project. Similarly, the second trend, the third trend and the fourth trend are determined for the project.

The second trend is calculated based on the developer parameters. As an example, the developer parameters may include, but not limited to, knowledge level of the developer, project development experience of the developer, defects introduced by the developer previously and number of trainings underwent by the developer. The trends determining module 223 classifies one or more of the developer parameters into one or more predefined categories. As an example, the one or more of the developer parameters to be classified may be knowledge level of the developer, project development experience of the developer and number of trainings underwent by the developer.

The one or more predefined categories associated with the knowledge level of the developer, experience of the developer in project development and number of trainings underwent by the developer are “low” “medium” and “high”.

The predefined categories “low”, “medium” and “high” are assigned with a second predefined scaling value. The second predefined scaling value of the predefined categories for the knowledge level of the developer, experience of the developer in project development and number of trainings is as shown in the below Table 8.

TABLE 8

| | Second Predefined |
|---|---|
| Predefined categories | scaling value |
| Low | 1 |
| Medium | 2 |
| High | 3 |

According to the above Table 8, the predefined category “low” is assigned with the second predefined scaling value 1, the predefined category “medium” is assigned with the second predefined scaling value 2 and the predefined category “high” is assigned with the second predefined scaling value 3.

Upon classification of the one or more of the developer parameters and assigning the second predefined scaling value to each of the one or more predefined categories, the trends determining module 223 determines the second trend. Table 9 comprises the second predefined scaling value for the one or more of the developer parameters and value associated with remaining of the developer parameters. As an example, the trends determining module 223 determines the second trend using the Equation 2 by substituting the values from the below Table 9.

TABLE 9

| | | | Defects | Number of | |
|---|---|---|---|---|---|
| | | Experience of | introduced | training | |
| | | the developer | by the | underwent | |
| | Knowledge | is project | developer | by the | Second |
| Project | Level | development | previously | developer | trend |
| A | 1 | 2 | 1 | 1 | 2 |
| B | 2 | 2 | 2 | 2 | 4 |
| C | 1 | 1 | 2 | 1 | 0.5 |

According to the above Table 9, the second trend computed for the project A is 2, the second trend computed for the project B is 4 and the second trend computed for the project C is 0.5. In an embodiment, higher the second trend better will be the trend of the project.

The third trend is calculated based on the production defect parameters. As an example, the production defect parameters may include, but not limited to, the second trend, criticality of the production defects, recurrence of the production defects and total number of production defects introduced by the developer. The trends determining module 223 classifies one or more of the production defect parameters into one or more predefined categories. As an example, the one or more of the production defect parameters to be classified may be criticality of the production defects and the recurrence of the production defects.

The one or more predefined categories associated with the criticality of the production defects are “low” “medium” and “high”. The predefined categories “low”, “medium” and “high” are assigned with a third predefined scaling value. The third predefined scaling value of the predefined categories for the criticality of the production defects is as shown in the below Table 10.

TABLE 10

| Predefined categories for criticality | Third Predefined scaling |
|---|---|
| of production defects | value |
| Low | 1 |
| Medium | 2 |
| High | 3 |

According to the above Table 10, the predefined category “low” is assigned with the third predefined scaling value 1, the predefined category “medium” is assigned with the third predefined scaling value 2 and the predefined category “high” is assigned with the third predefined scaling value 3.

The one or more predefined categories associated with the recurrence of the production defects are “yes” and “no”. The predefined categories “yes” and “no” are assigned with a third predefined scaling value. The third predefined scaling value of the predefined categories for the recurrence of the production defects is as shown in the below Table 11.

TABLE 11

| Predefined Categories for recurrence | Third Predefined scaling |
|---|---|
| of production defects | value |
| Yes | 1 |
| No | 0 |

According to the above Table 11, the predefined category “yes” is assigned with the third predefined scaling value 1 and the predefined category “no” is assigned with the third predefined scaling value 0.

Upon classification of the one or more of the production defect parameters and assigning the third predefined scaling value to each of the one or more predefined categories, the trends determining module 223 determines the third trend. Table 12 comprises the third predefined scaling value for the one or more of the production defect parameters and value associated with rest of the production defect parameters. As an example, the trends determining module 223 determines the third trend using the Equation 3 by substituting the values from the below Table 12.

TABLE 12

| | | Criticality | Recurrence | | |
|---|---|---|---|---|---|
| | Total number | of the | of the | | |
| | of production | production | production | Second | Third |
| Project | Defects | defect | defect | trend | trend |
| A | 1 | 2 | 0 | 2 | 2.00 |
| B | 5 | 3 | 1 | 4 | 0.50 |
| C | 2 | 1 | 0 | 0.5 | 0.25 |

According to the above Table 12, the third trend computed for the project A is 2.00, the third trend computed for the project B is 0.50 and the third trend computed for the project C is 0.25. In an embodiment, higher the third trend better will be the trend of the project.

The fourth trend is calculated based on the defect parameters, the test case parameters and the requirement parameters. As an example, the requirement parameters may include, but not limited to, total number of requirements available for the project, total number of defects in the requirements and industry standard of the requirements. The trends determining module 223 determines the fourth trend based on the value associated with the one or more defect parameters, the one or more test case parameters and a requirement stability value. As an example, the trends determining module 223 determines the requirement stability value based on value associated with the requirement parameters using the Equation 5 by substituting the values from the below Table 13.

TABLE 13

| | Total number of | Total number of | Requirement |
|---|---|---|---|
| | defects in the | requirements available | stability |
| Project | requirements | for the project | value |
| A | 40 | 30 | 1.33 |
| B | 7 | 10 | 0.70 |
| C | 30 | 50 | 0.60 |

According to the above Table 13, the requirement stability value computed for the project A is 1.33, the requirement stability value computed for the project B is 0.70 and the requirement stability value computed for the project C is 0.60. As an example, the trends determining module 223 determines the fourth trend using the Equation 4 by substituting the values from the below Table 14.

TABLE 14

| | | | Total | |
|---|---|---|---|---|
| | | | number of | |
| | Total number of | Requirement | test cases | |
| Project | defects found | Stability value | Executed | Fourth trend |
| A | 50 | 1.33 | 80 | 3.29 |
| B | 22 | 0.70 | 20 | 1.88 |
| C | 35 | 0.60 | 10 | 0.12 |

According to the above Table 14, the fourth trend computed for the project A is 3.29, the fourth trend computed for the project B is 1.88 and the fourth trend computed for the project C is 0.12. In an embodiment, lesser the ratio in determining the fourth trend, better will be the trend of the project.

In an embodiment, the project release prediction module 225 determines the project release prediction value for the project based on the first trend and the third trend. As an example, the project release prediction module 225 determines the project release prediction value using the Equation 6 by substituting the values from the below Table 15.

TABLE 15

| | | | Project release |
|---|---|---|---|
| Project | First trend | Third trend | prediction value |
| A | 648 | 2.00 | 324.00 |
| B | 424 | 0.50 | 848.00 |
| C | 112 | 0.25 | 448.00 |

According to the above Table 15, the project release prediction value computed for the project A is 324.00, the project release prediction value computed for the project B is 848.00 and the project release prediction value computed for the project C is 448.00.

The project release prediction value quantifies the completeness of the project to check if the project is ready for release. Further, the project release prediction value checks the level of correctness of the plurality of trends i.e. the project release prediction value indicates possibility of wrong trending by the plurality of trends and possibility of correct trending by the plurality of trends. In an embodiment, higher the project release prediction value better will be the release of the project.

In an embodiment, the impact determining module 227 determines the impact value of the project based on the second trend and the fourth trend. As an example, the impact determining module 227 determines the impact value using the Equation 7 by substituting the values from the below Table 16.

TABLE 16

| Project | Second tread | Fourth tread | Impact value |
|---|---|---|---|
| A | 2 | 3.29 | 6.58 |
| B | 4 | 1.88 | 7.52 |
| C | 0.5 | 0.12 | 0.06 |

According to the above Table 16, the impact value computed for the project A is 6.58, the impact value computed for the project B is 7.52 and the impact value computed for the project C is 0.06.

The impact value provides important information about production release of the project based on skill of the developer of the project and testing team. In an embodiment, lower the impact value better will be the impact on the project.

In an embodiment, the stability prediction module 229 determines the prediction result value of the project based on the project release prediction value and the impact value. As an example, the stability prediction module 229 determines the prediction result value using the Equation 8 by substituting the values from the below Table 17.

TABLE 17

| | | Project release | Prediction |
|---|---|---|---|
| Project | Impact value | prediction value | result value |
| A | 6.58 | 324.00 | 2.03% |
| B | 7.52 | 848.00 | 0.887% |
| C | 0.06 | 448.00 | 0.013% |

In an embodiment, the prediction result value is categorized in terms of one of the categories “highly unstable”, “somewhat stable”, “stable” and “highly stable”. If the prediction result value is in a range of 0%-7%, then the project is predicted to be “highly unstable”. If the prediction result value is in a range of 8%-16%, then the project is predicted to be “somewhat stable/unstable”. If the prediction result value is in a range of 16%-25%, then the project is predicted to be “stable”. If the prediction result value is in a range greater than 25%, then the project is predicted to be “highly stable”. As an example, the prediction result value of the project A is 2.03%. Therefore, the project is predicted to be “highly unstable”.

After predicting the stability of the project, the optimizing module 230 may optimize the stability of the project by dynamically performing one or more actions. The one or more actions may include modifying at least one of the defect parameters, the test case parameters, the developer parameters, the production defect parameters, and the requirement parameters to modify the prediction result value. For example, if the prediction result value is in the range of 0%-7%, a parameter contributing to the instability of the project may be identified. Further, the optimizing module 230 may modify the value of the identified parameter to adjust the prediction result value in a range in which the project may be determined as stable.

In one embodiment, consider the below example, in which the prediction result value is determined for three projects, project A, project B, and project C.

TABLE 18

| Input | | | Output |
|---|---|---|---|
| | | Release | Prediction |
| | Impact | Prediction | Result |
| Project | Value | Score | Value |
| A | 9.88 | 53.70 | 18% |
| B | 5.37 | 31.40 | 17% |
| C | 2.70 | 32.00 | 8% |

As shown in the Table 18, the prediction result value of the project C is in the range of 8%-16%. Therefore, the project C is predicted as “somewhat stable” or “unstable”. In order to optimize the stability of the project, the optimizing module 230 may identify that the impact value needs to be modified. The optimizing module 230 may further identify the parameters required to be modified to modify the impact value and the prediction result value.

TABLE 19

| | |
|---|---|
| Input | Output |

| Second Trend | Fourth Trend | Impact Value |
|---|---|---|
| 2.7 | 3.66 | 9.88 |
| 1.6 | 3.36 | 5.37 |
| 0.5 | 5.39 | 2.70 |

As shown in the Table 19, the optimizing module 230 may identify that the impact value is dependent on the second trend and the fourth trend. The second trend provides insights on the developer of the project based on the developer parameters. The developer parameters may include knowledge level of the developer, experience of the developer in project development, number of trainings underwent by the developer, and total defects introduced by the developer previously.

TABLE 20

| Input | | | | | Output |
|---|---|---|---|---|---|
| | | Experience | Total | | Second |
| | Knowledge | of the | defects | Trainings | Trend/ |
| | Level | Developer | introduced | (3- High, | Developer |
| | (3- High, | (3- High, | by the | 2- | Overall |
| Proj- | 2- Medium, | 2- Medium, | developer | Medium, | Experience |
| ect | 1- Low) | 1- Low) | previously | 1- Low) | Trend |
| A | 3 | 3 | 10 | 3 | 2.7 |
| B | 2 | 2 | 5 | 2 | 1.6 |
| C | 1 | 1 | 2 | 1 | 0.5 |

As shown in the Table 20, for the project C, the experience of the developer is 1 i.e. low. Therefore, the optimizing module 230 may identify that modifying experience of the developer may improve the second trend, the impact value, the prediction result value, and thereby the stability of the project. The optimizing module 230 may modify the experience of the developer to 3 i.e. the optimizing module 230 may dynamically assign a developer with a high developer experience to project C.

TABLE 21

| Input | | | | | Output |
|---|---|---|---|---|---|
| | | Experience | Total | | Developer |
| | Knowledge | of the | defects | Trainings | Overall |
| | Level | developer | introduced | (3- High, | Experience |
| | (3- High, | (3- High, | by the | 2- | Trend/ |
| Proj- | 2- Medium, | 2- Medium, | developer | Medium, | Second |
| ect | 1- Low) | 1- Low) | previously | 1- Low) | Trend |
| A | 3 | 3 | 10 | 3 | 2.7 |
| B | 2 | 2 | 5 | 2 | 1.6 |
| C | 1 | 3 | 2 | 1 | 1.5 |

Table 21 depicts change in the second trend or the developer overall experience trend based on modification in the experience of the developer.

TABLE 22

Input

| Developer | | |
|---|---|---|
| Overall | | |
| Experience | Testing | |
| Trend/Second | Effectiveness/ | Output |
| Trend | Fourth Trend | Impact Value |
| 2.7 | 3.66 | 9.88 |
| 1.6 | 3.36 | 5.37 |
| 1.5 | 5.39 | 8.09 |

Table 22 depicts change in the impact value based on the modification in the developer overall experience trend or the second trend.

TABLE 23

| Input | | | |
|---|---|---|---|
| | | Release | Output |
| | Impact | Prediction | Prediction |
| Project | Value | Score | Result value |
| A | 9.88 | 53.70 | 18% |
| B | 5.37 | 31.40 | 17% |
| C | 8.09 | 32.00 | 25% |

The table 23 depicts change in the prediction result value based on the modification in the impact value. As shown in the table 23, the prediction result value is modified from 8 to 25. The prediction result value of 25 is in the range 16%-25% i.e. stable. Consequently, the project C may be predicted as stable based on the prediction result value of 25. Thus, the stability of the project C is improved from being unstable to stable by dynamically modifying the developer parameters.

FIG. 3 illustrates a flowchart for optimizing stability of a project, in accordance with some embodiments of the present disclosure.

As illustrated in FIG. 3, the method 300 comprises one or more blocks illustrating a method for predicting stability of a project. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, parameter data 104 is received from one or more data sources 103 by a predictive analysis system 107. In an embodiment, the parameter data 104 is received by a I/O interface 111 configured in the predictive analysis system 107. As an example, the one or more data sources 103 may include, but not limited to, a management system like test case management system, one or more databases like skill database of developers of a project, knowledge repositories etc. and user inputs. As an example, the parameter data 104 is related to the defect parameters, the developer parameters, the test case parameters, the requirement parameters and the production defect parameters of the project from the one or more data sources 103. The data related to the defect parameters comprises information about defects in the project. The data related to the developer parameters comprises information about developer of the project. The data related to the test case parameters comprises information about the test cases of the project. The data related to the requirement parameters comprises information about the requirements of the project. The data related to the production defect parameters comprises information about defects related to production of the project.

At block 303, plurality of trends is determined by the predictive analysis system 107. Determining the plurality of trends comprises determining a first trend, a second trend, a third trend and a fourth trend. The first trend provides insights on stability of the project based on the defect parameters and the test case parameters. The second trend provides insights on the developer of the project based on the developer parameters. The third trend provides insights on the production defects raised on a system and whether the production defects were fixed or not, based on the production defect parameters. The fourth trend provides insights on performance of testing team of the project based on the test case parameters, the defect parameters and the requirement parameters.

The first trend is calculated based on the defect parameters and the test case parameters. As an example, the defect parameters may include, but not limited to, total number of defects in the project, type of the defects, criticality of the defects, severity of the defects and root cause of the defects. As an example, the test case parameters may include, but not limited to, total number of test cases created, total number of test cases executed, priority of the test cases and status of the test cases.

The second trend is calculated based on the developer parameters. As an example, the developer parameters may include, but not limited to, knowledge level of the developer, experience of the developer in project development, defects introduced by the developer previously and number of trainings underwent by the developer.

The third trend is calculated based on the production defect parameters. As an example, the production defect parameters may include, but not limited to, the second trend, criticality of the production defects, recurrence of the production defects and total number of production defects introduced by the developer.

The fourth trend is calculated based on the defect parameters, the test case parameters and the requirement parameters. As an example, the requirement parameters may include, but not limited to, total number of requirements available for the project, total number of defects in the requirements and industry standard of the requirements.

At block 305, a project release prediction value is determined by the predictive analysis system 107. In an embodiment, the processor 109 uses the determined first trend and the third trend to determine the project release prediction value. The project release prediction value quantifies the completeness of the project to check if the project is ready for release. Further, the project release prediction value checks the level of correctness of the plurality of trends i.e. the project release prediction value indicates possibility of wrong trending and possibility of correct trending of the project based on the plurality of trends.

At block 307, an impact value is determined by the predictive analysis system 107. In an embodiment, the processor 109 uses the determined second trend and the fourth trend to determine the impact value of the project. The impact value provides important information about production release of the project based on skill of the developer of the project and testing team.

At block 309, a prediction result value is determined by the predictive analysis system 107. In an embodiment, the processor 109 uses the determined project release prediction value and the impact value to determine the prediction result value of the project. The prediction result value is a percentage value that predicts the stability of the project. The prediction result value is categorized in terms of one of the categories “highly unstable”, “somewhat stable”, “stable” and “highly stable”. Upon identifying the prediction result value, the stability of the project based on the prediction result value is notified to one or more end users 114 through the I/O interface 111. As an example, the one or more end users 114 may be one or more a stakeholder of an organization, a project head etc.

At block 311, one or more actions may be performed dynamically based on the prediction result value to optimize the stability of the project. The one or more actions may include modifying at least one of the defect parameters, the test case parameters, the developer parameters, the production defect parameters, and the requirement parameters to modify the prediction result value. For example, if the prediction result value is in the range of 0%-7%, a parameter contributing to the instability of the project may be identified. Further, the optimizing module may modify the value of the parameter to adjust the prediction result value in a range in which the project may be determined as stable. In one embodiment, the optimizing module 230 may optimize the stability of the project.

FIG. 4 is a block diagram of an exemplary computer system for implementing embodiments consistent with the present disclosure.

In an embodiment, the predictive analysis system 400 is used for optimizing stability of a project. The predictive analysis system 400 may comprise a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The 1/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the predictive analysis system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the predictive analysis system 400 may communicate with one or more data sources 410 (a, . . . , n). The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more data sources 410 (a, . . . , n) may include, without limitation, personal computer(s), mobile devices such as cellular telephones, smartphones, tablet computers, eBook readers, laptop computers, notebooks, gaming consoles, or the like.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface application 406, an operating system 407, web server 408 etc. In some embodiments, predictive analysis system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the predictive analysis system 400. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the predictive analysis system 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the predictive analysis system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTITPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the predictive analysis system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the predictive analysis system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Advantages of the embodiment of the present disclosure are illustrated herein.

In an embodiment, the present disclosure provides a method and a system for optimizing stability of a project.

The present disclosure provides a feature wherein the prediction result value can be determined at any stage of the invention to check if the project is ready for release. Also, the predictive analysis system can determine if the project is undergoing correct trending or wrong trending.

The present disclosure provides a feature wherein each and every parameter related to the project is evaluated uniquely to make the security to the application more impactful and to provide a holistic view of the project.

The present disclosure provides a feature wherein the already available data related to the application is used to implement the method and provides a structured result that helps in better understanding.

The present disclosure provides a feature wherein, the stability of the project may be optimized by improved dynamically by performing one or more actions.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for optimizing stability of a project. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

Referral numerals

| Reference Number | Description |
|---|---|
| 100 | Architecture |
| 103 | One or more data sources |
| 104 | Parameter data |
| 105 | Communication network |
| 107 | Predictive analysis system |
| 109 | Processor |
| 111 | I/O interface |
| 113 | Memory |
| 114 | One or more end users |
| 203 | Data |
| 205 | Modules |
| 209 | Trends data |
| 213 | Project release prediction data |
| 215 | Impact data |
| 217 | Prediction result data |
| 219 | Other data |
| 221 | Receiving module |
| 223 | Trends determining module |
| 225 | Project release prediction module |
| 227 | Impact determining module |
| 229 | Stability prediction module |
| 230 | Optimizing Module |
| 231 | Other modules |

We claim:

1. A method for optimizing stability of a project, the method comprising:
receiving, by a predictive analysis system, data related to defect parameters, developer parameters, test case parameters, requirement parameters, and production defect parameters of a project from one or more data sources;
determining, by the predictive analysis system, plurality of trends based on at least one of the data related to the defect parameters, the test case parameters, the developer parameters, the production defect parameters, and the requirement parameters;
determining, by the predictive analysis system, a project release prediction value for the project based on at least one of the plurality of trends, wherein the project release prediction value indicates completeness of the project and level of correctness of at least one of the plurality of trends for release of the project;
determining, by the predictive analysis system, an impact value of the project based on at least one of the plurality of trends, wherein the impact value indicates impact of at least one of the plurality of trends on production release of the project;
determining, by the predictive analysis system, a prediction result value based on the project release prediction value and the impact value for predicting the stability of the project; and
performing dynamically, by the predictive analysis system, one or more actions based on the prediction result value for optimizing the stability of the project.

2. The method as claimed in claim 1, wherein determining the plurality of trends comprises determining a first trend by:
classifying, by the predictive analysis system, one or more of the defect parameters and one or more of the test case parameters into one or more predefined categories;
assigning, by the predictive analysis system, a first predefined scaling value to each of the one or more predefined categories; and
determining, by the predictive analysis system, the first trend based on the first predefined scaling value and value associated with remaining of the defect parameters and remaining of the test case parameters.

3. The method as claimed in claim 1, wherein determining the plurality of trends comprises determining a second trend by:
classifying, by the predictive analysis system, one or more of the developer parameters into a low category, a medium category and a high category;
assigning, by the predictive analysis system, a second predefined scaling value to each of the low category, the medium category and the high category; and
determining, by the predictive analysis system, the second trend based on the second predefined scaling value and value associated with remaining of the developer parameters.

4. The method as claimed in claim 1, wherein determining the plurality of trends comprises determining a third trend by:
classifying, by the predictive analysis system, one or more of the production defect parameters into a low category, a medium category and a high category;
assigning, by the predictive analysis system, a third predefined scaling value to each of the low category, the medium category and the high category; and
determining, by the predictive analysis system, the third trend based on the third predefined scaling value and value associated with remaining of the production defect parameters.

5. The method as claimed in claim 1, wherein determining the plurality of trends comprises determining a fourth trend based on a requirement stability value, value associated with one or more of the defect parameters and value associated with one or more of the test case parameters.

6. The method as claimed in claim 5, wherein the requirement stability value is determined based on a value associated with the requirement parameters.

7. The method as claimed in claim 1, wherein the one or more actions comprises dynamically modifying at least one of the defect parameters, the test case parameters, the developer parameters, the production defect parameters, and the requirement parameters to modify the prediction result value.

8. A predictive analysis system for optimizing stability of a project, the predictive analysis system comprising:
a processor; and
a memory communicatively coupled to the processor, wherein the memory stores the processor-executable instructions, which, on execution, causes the processor to:
receive data related to defect parameters, developer parameters, test case parameters, requirement parameters and production defect parameters of a project from one or more data sources;
determine plurality of trends based on at least one of the data related to the defect parameters, the test case parameters, the developer parameters, the production defect parameters and the requirement parameters;
determine a project release prediction value for the project based on at least one of the plurality of trends, wherein the project release prediction value indicates completeness of the project and level of correctness of at least one of the plurality of trends for release of the project;
determine an impact value of the project based on at least one of the plurality of trends, wherein the impact value indicates impact of at least one of the plurality of trends on production release of the project;
determine a prediction result value based on the project release prediction value and the impact value for predicting the stability of the project; and
dynamically perform one or more actions based on the prediction result value for optimizing the stability of the project.

9. The predictive analysis system as claimed in claim 8, wherein the processor determines the plurality of trends by determining a first trend comprising:
classifying one or more of the defect parameters and one or more of the test case parameters into one or more predefined categories;
assigning a first predefined scaling value to each of the one or more predefined categories; and
determining the first trend based on the first predefined scaling value and value associated with remaining of the defect parameters and remaining of the test case parameters.

10. The predictive analysis system as claimed in claim 8, wherein the processor determines the plurality of trends by determining a second trend comprising:
classifying one or more of the developer parameters into a low category, a medium category and a high category;
assigning a second predefined scaling value to each of the low category, the medium category and the high category; and
determining the second trend based on the second predefined scaling value and value associated with remaining of the developer parameters.

11. The predictive analysis system as claimed in claim 8, wherein the processor determines the plurality of trends by determining a third trend comprising:
classifying one or more of the production defect parameters into a low category, a medium category and a high category;
assigning a third predefined scaling value to each of the low category, the medium category and the high category; and
determining the third trend based on the third predefined scaling value and value associated with remaining of the production defect parameters.

12. The predictive analysis system as claimed in claim 8, wherein the processor determines the plurality of trends by determining a fourth trend based on a requirement stability value, value associated with one or more of the defect parameters and value associated with one or more of the test case parameters.

13. The predictive analysis system as claimed in claim 12, wherein the processor determines the requirement stability value based on a value associated with the requirement parameters.

14. The predictive analysis system as claimed in claim 8, wherein the one or more actions comprises dynamically modifying at least one of the defect parameters, the test case parameters, the developer parameters, the production defect parameters, and the requirement parameters to modify the prediction result value.

15. A non-transitory computer-readable storage medium having stored thereon, a set of computer-executable instructions for causing a computer comprising one or more processors to perform steps comprising:
receiving data related to defect parameters, developer parameters, test case parameters, requirement parameters, and production defect parameters of a project from one or more data sources;
determining plurality of trends based on at least one of the data related to the defect parameters, the test case parameters, the developer parameters, the production defect parameters, and the requirement parameters;
determining a project release prediction value for the project based on at least one of the plurality of trends, wherein the project release prediction value indicates completeness of the project and level of correctness of at least one of the plurality of trends for release of the project;
determining an impact value of the project based on at least one of the plurality of trends, wherein the impact value indicates impact of at least one of the plurality of trends on production release of the project
determining a prediction result value based on the project release prediction value and the impact value for predicting the stability of the project; and
performing dynamically one or more actions based on the prediction result value for optimizing the stability of the project.

16. The non-transitory computer-readable storage medium of claim 15, wherein the steps for determining the plurality of trends comprises determining a first trend by:
classifying one or more of the defect parameters and one or more of the test case parameters into one or more predefined categories;
assigning a first predefined scaling value to each of the one or more predefined categories; and
determining the first trend based on the first predefined scaling value and value associated with remaining of the defect parameters and remaining of the test case parameters.

17. The non-transitory computer-readable storage medium of claim 15, wherein the steps for determining the plurality of trends comprises determining a second trend by:
classifying one or more of the developer parameters into a low category, a medium category and a high category;
assigning a second predefined scaling value to each of the low category, the medium category and the high category; and
determining the second trend based on the second predefined scaling value and value associated with remaining of the developer parameters.

18. The non-transitory computer-readable storage medium of claim 15, wherein the steps for determining the plurality of trends comprises determining a third trend by:
classifying one or more of the production defect parameters into a low category, a medium category and a high category;
assigning a third predefined scaling value to each of the low category, the medium category and the high category; and
determining the third trend based on the third predefined scaling value and value associated with remaining of the production defect parameters.

19. The non-transitory computer-readable storage medium of claim 15, wherein the steps for determining the plurality of trends comprises determining a fourth trend based on a requirement stability value, value associated with one or more of the defect parameters and value associated with one or more of the test case parameters.

20. The non-transitory computer-readable storage medium of claim 15, wherein the one or more actions comprises dynamically modifying at least one of the defect parameters, the test case parameters, the developer parameters, the production defect parameters, and the requirement parameters to modify the prediction result value.
